(19) United States
(12) Patent Application Publication
(10) Pub. No.: US 2026/0018604 A1
(43) Pub. Date: Jan. 15, 2026

(54) CATHODE ACTIVE MATERIAL FOR LITHIUM-ION BATTERY AND PRODUCING METHOD THEREOF

(71) Applicant: NICHIA CORPORATION, Anan-shi (JP)

(72) Inventors: Masahiro KANEKO, Tokushima-shi (JP); Tomooki KAWASAKI, Anan-shi (JP)

(73) Assignee: NICHIA CORPORATION, Anan-shi (JP)

(21) Appl. No.: 19/264,849

(22) Filed: Jul. 9, 2025

(30) Foreign Application Priority Data
Jul. 11, 2024 (JP) 2024-111895

(51) Int. Cl. H01M 4/525; H01M 4/02; H01M 10/0525

(52) U.S. Cl. CPC H01M 4/525; H01M 10/0525; H01M 2004/021; H01M 2004/028

(57) ABSTRACT

Provided is a cathode active material for a lithium-ion battery that can reduce gas generation in the cathode and exhibits an excellent filling property. Also provided is a method of producing a cathode active material for a lithium-ion battery, the method including preparing a mixture comprising a lithium transition metal composite oxide having a layered structure, containing lithium and nickel in a composition, and containing secondary particles formed by aggregation of a plurality of primary particles, the secondary particles having a volume-average particle diameter greater than 3 μm and less than 5 μm, and a treatment solution containing a sulfate ion and a liquid medium, a concentration of the sulfate ion being in a range of 1 mass % to 9 mass %; and removing the treatment solution from the mixture.

### CROSS-REFERENCE TO RELATED APPLICATIONS

This application claims priority to Japanese Patent Application No. 2024-111895, filed on Jul. 11, 2024, the disclosure of which is hereby incorporated by reference in its entirety.

### BACKGROUND

### Field of the Invention

The present disclosure relates to a cathode active material for a lithium-ion battery and a producing method thereof.

### Description of the Related Art

As cathode active materials for lithium-ion batteries, lithium transition metal composite oxides such as lithium nickel cobalt manganese oxide are used. A lithium-nickel-based composite oxide having an increased ratio of nickel to decrease the usage of cobalt, which is a scarce resource, has an advantage that a charge-discharge capacity per unit weight is high. However, lithium-nickel-based composite oxides are difficult to synthesize, and unreacted raw materials may remain as alkaline components. The residual alkaline components can cause issues such as slurry thickening during electrode fabrication and gas generation during charging. For example, JP 2021-015790 A describes a method in which a lithium transition metal composite oxide is brought into contact with a solution containing sodium ions, followed by mixing with a boron compound and subjecting the mixture to heat treatment.

In addition, in lithium-ion batteries, increasing the density of the cathode active material layer is required. For example, JP 2022-060686 A describes cathode active material powder that contains a first particle group containing a plurality of first particles, each containing one to 10 single particles and having a maximum diameter of 0.5 μm or greater, and a second particle group containing a plurality of aggregated particles formed by aggregation of 50 or more primary particles having a maximum diameter of less than 0.5 μm.

### SUMMARY

The single particles described in JP 2022-060686 A have a problem related to environmental burden, such as a high heat treatment temperature during manufacture. An aspect of the present disclosure aims to provide a cathode active material for a lithium-ion battery and a producing method thereof, with which gas generation at a cathode is reduced and an excellent filling property are achieved.

A first aspect is a method of producing a cathode active material for a lithium-ion battery, the method including preparing a mixture including a lithium transition metal composite oxide containing lithium and nickel in a composition and containing secondary particles formed by aggregation of a plurality of primary particles, the secondary particles having a volume-average particle diameter greater than 3 μm and less than 5 μm, and a treatment solution containing a sulfate ion and a liquid medium, a concentration of the sulfate ion being in a range of 1 mass % to 9 mass %; and removing the treatment solution from the mixture.

A second aspect is a cathode active material for a lithium-ion battery including a lithium transition metal composite oxide containing lithium and nickel in a composition and containing secondary particles formed by aggregation of a plurality of primary particles, the secondary particles having a volume-average particle diameter greater than 3 μm and less than 5 μm; and a sulfate ion, in which the content of the sulfate ion is greater than 500 ppm and 6500 ppm or less, and the content of boron with respect to the lithium transition metal composite oxide is less than 1 mol %.

According to an aspect of the present disclosure, it is possible to provide a cathode active material for a lithium-ion battery and a producing method thereof, with which gas generation at the cathode can be reduced and an excellent filling property can be achieved.

### DETAILED DESCRIPTION

In the present specification, the word “step” herein includes not only an independent step, but also a step that cannot be clearly distinguished from another step if the anticipated purpose of the step is achieved. When a plurality of substances applicable to a single component in a composition are present, the content of the single component in the composition means the total amount of the plurality of substances present in the composition, unless otherwise specified. Furthermore, with respect to an upper limit and a lower limit of numerical ranges described herein, the numerical values exemplified as the numerical range can be freely selected and combined. Embodiments of the present disclosure are described below in detail. Note that, the embodiments described below merely exemplify a cathode active material for a lithium-ion battery and a producing method thereof that concretely embody the technical concept of the present disclosure, and the present disclosure is not limited to the cathode active material for a lithium-ion battery and the producing method thereof described below.

Method of Producing Cathode Active Material for Lithium-ion Battery A method of producing a cathode active material for a lithium-ion battery (hereinafter referred to simply as “cathode active material”) includes a first step of preparing a mixture containing a lithium transition metal composite oxide and a treatment solution, and a second step of obtaining a cathode active material by removing the treatment solution from the mixture. The lithium transition metal composite oxide may have a composition including lithium and nickel. In addition, the lithium transition metal composite oxide may contain secondary particles formed by aggregation of a plurality of primary particles, and the secondary particles may have a volume-average particle diameter greater than 3 μm and less than 5 μm. The treatment solution may contain sulfate ions and a liquid medium. The mixture may have a sulfate-ion concentration in a range from 0.5 mass % to 5 mass %.

By washing the lithium transition metal composite oxide with a treatment solution containing sulfate ions, the residual alkaline component can be efficiently removed, effectively suppressing or reducing gas generation during charging when a cathode is formed. In addition, since the lithium transition metal composite oxide is small-diameter aggregated particles having a specific particle diameter, the filling density in a cathode can be effectively improved when the lithium transition metal composite oxide is combined with a cathode active material with a large particle diameter.

In a first step of the method of producing a cathode active material, a mixture containing a lithium transition metal composite oxide containing secondary particles formed by aggregation of a plurality of primary particles and a treatment solution containing sulfate ions and a liquid medium is prepared. The first step may include a preparation step of preparing the lithium transition metal composite oxide, and a mixing step of mixing the prepared lithium transition metal composite oxide with the treatment solution to prepare a mixture.

In the preparation step, the lithium transition metal composite oxide may be prepared by purchasing it, or by producing a desired lithium transition metal composite oxide. The method of producing the lithium transition metal composite oxide will be described later.

The lithium transition metal composite oxide to be prepared may contain secondary particles formed by aggregation of a plurality of primary particles, or may be composed of secondary particles. The primary particles may contain a lithium transition metal composite oxide containing lithium and a transition metal such as nickel, or may be a single crystal of a lithium transition metal composite oxide. The lithium transition metal composite oxide may have a layered structure. The average particle diameter of the primary particles, as an average particle diameter D_{SEM} based on electron microscope observation, may be, for example, 1 μm or less, preferably 600 nm or less, 300 nm or less, or 100 nm or greater. In addition, the volume-average particle diameter D₅₀ of the secondary particles may be, for example, in a range from 2 μm and 6 μm, preferably greater than 3 μm and less than 5 μm, or in a range from 3.5 μm to 4.5 μm. The number of primary particles constituting each of the secondary particles of the lithium transition metal composite oxide may be, for example, in a range from 20 to 10000, preferably in a range from 200 to 1000. In addition, in the secondary particles of the lithium transition metal composite oxide, the ratio of the volume-average particle diameter D₅₀ to the average particle diameter D_{SEM} based on electron microscope observation (D₅₀/D_{SEM}) may be, for example, in a range from three to 20, preferably in a range from five to 10. Note that, the volume-average particle diameter refers to the value at which the cumulative volume from the smaller particle diameter side reaches 50% in the volume-based particle size distribution obtained by a laser scattering method.

The average particle diameter D_{SEM} based on electron microscope observation is an average value of the volume equivalent diameters of the primary particles measured from a scanning electron microscope (SEM) image. More specifically, the average particle diameter D_{SEM} is measured in the following manner. A scanning electron microscope (SEM) is used to observe the primary particles at a magnification ranging from 1000 to 10000 times, depending on the particle diameter. 100 primary particles with clearly identifiable contours are selected. Using image processing software, the contour of each of the selected primary particles is traced to determine its perimeter length. The volume equivalent diameters are then calculated from the perimeter lengths, and the arithmetic mean of the obtained volume equivalent diameters is obtained as the average particle diameter D_{SEM}.

In the composition of the lithium transition metal composite oxide, the ratio of the number of moles of nickel to the total number of moles of metals other than lithium may be, for example, 0.5 or greater and less than 1, preferably 0.7 or greater and less than 1, more preferably in a range from 0.7 to 0.95, in a range from 0.75 to 0.95, or in a range from 0.8 to 0.95. The lithium transition metal composite oxide may contain cobalt. In a case in which the lithium transition metal composite oxide contains cobalt, the ratio of the number of moles of cobalt to the total number of moles of metals other than lithium may be, for example, greater than 0 and 0.3 or less, preferably 0.01 or greater and less than 0.2, 0.02 or greater, or 0.05 or greater. The lithium transition metal composite oxide may contain manganese. In a case in which the lithium transition metal composite oxide contains manganese, the ratio of the number of moles of manganese to the total number of moles of metals other than lithium may be, for example, greater than 0 and 0.3 or less, preferably greater than 0 and 0.15 or less, or in a range from 0.01 to 0.15. The lithium transition metal composite oxide may contain aluminum. In a case in which the lithium transition metal composite oxide contains aluminum, the ratio of the number of moles of aluminum to the total number of moles of metals other than lithium may be, for example, greater than 0 and 0.1 or less, preferably greater than 0 and 0.05 or less, or in a range from 0.01 to 0.04. In a case in which the lithium transition metal composite oxide contains at least one of manganese and aluminum, the ratio of the total number of moles of manganese and aluminum to the total number of moles of metals other than lithium may be, for example, greater than 0 and 0.3 or less, preferably greater than 0 and 0.25 or less, or in a range from 0.01 to 0.15.

The lithium transition metal composite oxide may, for example, have a composition represented by the following formula (1).

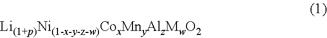

In the formula, −0.05≤p≤0.2, 0<x+y+z+w≤0.3, 0≤x≤0.3, 0≤y≤0.3, 0≤z≤0.1, 0≤w≤0.03 are satisfied. M includes at least one selected from the group consisting of Zr, Ti, Mg, Ta, Nb, Mo, and W.

In the lithium transition metal composite oxide, the content of boron with respect to the lithium transition metal composite oxide may be, for example, less than 1 mol %. In a case in which the content of boron in the lithium transition metal composite oxide is less than 1 mol %, the electrode plate density of the cathode that is formed using the cathode active material containing the lithium transition metal composite oxide tends to increase. The content of boron with respect to the lithium transition metal composite oxide is preferably 0.5 mol % or less or 0.1 mol % or less.

The treatment solution needs only to contain at least sulfate ions and liquid medium. The treatment solution containing sulfate ions can be prepared, for example, by dissolving sulfate in a liquid medium. Examples of sulfate include alkali metal sulfates such as lithium sulfate, sodium sulfate, and potassium sulfate; group 2 element sulfates such as calcium sulfate and magnesium sulfate; and ammonium sulfate. It is preferable that the sulfate contains at least one selected from the group consisting of alkali metal sulfates, and more preferably contains at least one of lithium sulfate and sodium sulfate. The liquid medium may contain at least water, for example, and in addition to water, it may optionally contain a water-soluble organic solvent such as an alcohol. The content of sulfate ions in the treatment solution may be, for example, in a range from 0.1 mass % to 6 mass %, preferably 1 mass % or greater, 2 mass % or greater, 5 mass % or less, or 4 mass % or less. When the treatment solution contains sulfate ions, residual alkaline components (e.g., lithium carbonate, lithium hydroxide, or the like) present in the lithium transition metal composite oxide can be effectively removed. In addition, the attachment of sulfate ions to the surface of the lithium transition metal composite oxide tends to improve its dispersibility and alter the interactions between the particles, thereby improving the filling property when the lithium transition metal composite oxide is used in formation of a cathode.

The treatment solution may further contain sodium ions. When the treatment solution contains sodium ions, residual alkali present in the lithium transition metal composite oxide can be effectively removed. In addition, the attachment of sodium ions to the surface of the lithium transition metal composite oxide tends to improve the filling property when the lithium transition metal composite oxide is used in formation of a cathode. In a case in which the treatment solution contains sodium ions, the content of the sodium ions in the treatment solution may be, for example, in a range from 0.1 mass % to 2 mass %, preferably 0.3 mass % or greater, 0.6 mass % or greater, 1.5 mass % or less, or 1.0 mass % or less.

The treatment solution may further contain lithium ions, and may further contain lithium ions in addition to sodium ions. When the treatment solution contains lithium ions, elimination of the lithium ions in the lithium transition metal composite oxide can be suppressed, and favorable charge-discharge capacity and cycle performance can be achieved. In a case in which the treatment solution contains lithium ions, the content of the lithium ions in the treatment solution may be, for example, in a range from 0.01 mass % to 0.6 mass %, preferably 0.1 mass % or greater, 0.2 mass % or greater, 0.5 mass % or less, or 0.4 mass % or less.

In the mixing step, a mixture is prepared by mixing the prepared lithium transition metal composite oxide and the treatment solution. The mixture may be prepared by putting the lithium transition metal composite oxide into the treatment solution to form a slurry, or by adding the treatment solution to the lithium transition metal composite oxide to form a slurry. In the mixture, the solid content concentration, which is the mass ratio of the lithium transition metal composite oxide to the mixture, may be, for example, in a range from 30 mass % to 70 mass %, preferably 40 mass % or greater, or 60 mass % or less.

The concentration of the sulfate ions contained in the mixture may be, for example, in a range from 0.5 mass % to 5 mass %, preferably 1 mass % or greater, 1.5 mass % or greater, 4.5 mass % or less, or 3.5 mass % or less. More preferably, it may be in a range from 0.5 mass % to 4.5 mass %, in a range from 0.5 mass % to 3.5 mass %, in a range from 1 mass % to 5 mass %, in a range from 1 mass % to 4.5 mass %, in a range from 1 mass % to 3.5 mass %, in a range from 1.5 mass % to 5 mass %, in a range from 1.5 mass % to 4.5 mass %, or in a range from 1.5 mass % to 3.5 mass %. Here, the sulfate ions contained in the mixture may be derived from the treatment solution.

The mixture may contain metal ions in addition to the sulfate ions. The metal ions may be derived from the treatment solution and contained in the mixture. In a case in which the mixture contains two or more types of metal ions, the mixture may be prepared by mixing the treatment solution containing two or more types of metal ions and the lithium transition metal composite oxide, or the mixture containing two or more types of metal ions may be prepared by mixing a treatment solution containing sulfate ions and one type of metal ions (for example, sodium ions) with the lithium transition metal composite oxide, and thereafter adding a solution containing other metal ions (for example, lithium ions) thereto.

The mixture may contain sodium ions. In a case in which the mixture contains sodium ions, the concentration of the sodium ions in the mixture may be, for example, in a range of 0.1 mass % to 2 mass %, preferably 0.3 mass % or greater, 0.6 mass % or greater, 1.5 mass % or less, or 1.0 mass % or less. The concentration of sodium ions in the mixture is preferably in a range of 0.1 mass % to 1.5 mass %, in a range of 0.1 mass % to 1.0 mass %, in a range of 0.3 mass % to 2 mass %, in a range of 0.3 mass % to 1.5 mass %, in a range of 0.3 mass % to 1.0 mass %, in a range of 0.6 mass % to 2 mass %, in a range of 0.6 mass % to 1.5 mass %, or in a range of 0.6 mass % to 1.0 mass %. Here, the sodium ions contained in the mixture may be derived from the treatment solution.

The mixture may contain lithium ions, and may further contain lithium ions in addition to sodium ions. In a case in which the mixture contains lithium ions, the concentration of the lithium ions in the mixture may be, for example, in a range from 0.01 mass % to 0.6 mass %, preferably 0.1 mass % or greater, 0.2 mass % or greater, 0.5 mass % or less, or 0.4 mass % or less. The concentration of the lithium ions in the mixture may preferably be in a range of 0.01 mass % to 0.5 mass % or less, in a range of 0.01 mass % to 0.4 mass %, in a range of 0.1 mass % to 0.6 mass %, in a range of 0.1 mass % to 0.5 mass %, in a range of 0.1 mass % to 0.4 mass %, in a range of 0.2 mass % to 0.6 mass %, in a range of 0.2 mass % to 0.5 mass %, or in a range of 0.2 mass % to 0.4 mass %. Here, the lithium ions contained in the mixture may be derived from the treatment solution.

In a case in which the mixture contains sodium ions in addition to sulfate ions, the product of the mass-based concentration of the sulfate ions and the mass-based concentration of the sodium ions may be, for example, in a range from 0.1×10⁻⁴ to 5.0×10⁻⁴, preferably 0.5×10⁻⁴ or greater, or 3.5×10⁻⁴ or less, more preferably 1.5×10⁻⁴ or greater, or 3.0×10⁻⁴ or less. When the product of the sulfate-ion concentration and the sodium-ion concentration is within the above range, the amount of gas generation during formation of a cathode is likely to be further reduced. It is presumable that through the washing with the sodium sulfate and lithium sulfate, the sulfate ions and the sodium ions remaining on the surface of the cathode active material form a protective layer, and a direct reaction with an electrolytic solution is suppressed, thus reducing the amount of gas generation.

In the first step, the treatment solution containing the sulfate ions and the lithium transition metal composite oxide may be brought into contact with each other in a mixture state. The mixture may be stirred as necessary during the contact between the treatment solution and the lithium transition metal composite oxide. The contact temperature of the treatment solution and the lithium transition metal composite oxide may be, for example, in a range from 5° C. to 60° C., preferably in a range from 10° C. to 40° C. In addition, the contact time may be, for example, in a range from one minute to two hours, preferably in a range from two minutes to 30 minutes.

In the second step, at least part of the treatment solution is removed from the mixture to obtain the cathode active material as a solid. In removing the treatment solution from the mixture, it suffices to remove the treatment solution from the mixture to the extent that the resulting solid can be used as the cathode active material. The removal of the treatment solution from the mixture can be carried out by a solid-liquid separation means typically employed. Examples of solid-liquid separation means include filters and centrifuges. A drying treatment may be performed on the resulting dehydrated cake obtained by solid-liquid separation of the mixture. The drying treatment only needs to remove at least a portion of the moisture contained in the dehydrated cake, and may be carried out by a method such as heat drying, air-drying, or reduced-pressure drying. The drying temperature in the case of heat drying may be any temperature at which moisture contained in the cathode active material is sufficiently removed. For example, the drying temperature may be in a range from 80° C. to 300° C., preferably in a range from 150° C. to 280° C. When the drying temperature is within the above range, the elution of lithium into adhered water can be sufficiently suppressed. In addition, collapse of the crystal structures of the particle surfaces can be suppressed, thereby sufficiently preventing a decrease in charge-discharge capacity. The drying time may be appropriately selected according to the amount of moisture contained in the cathode active material. For example, the drying time may be in a range from one hour to 20 hours. In addition, the atmosphere for the drying treatment may be an inert gas atmosphere such as a nitrogen gas. The amount of moisture contained in the cathode active material after the drying treatment may be, for example, 0.2 mass % or less, preferably 0.1 mass % or less.

The lithium transition metal composite oxide prepared in the preparation step can be produced by the following manufacturing method, for example. The method of producing the lithium transition metal composite oxide may include, for example, a precursor preparation step of preparing a precursor, and a synthesis step of synthesizing the lithium transition metal composite oxide from the precursor and a lithium compound.

In the precursor preparation step, a precursor containing nickel is prepared. The precursor may be prepared, for example, by purchasing it, or it may be prepared by a conventional method so as to have a desired composition. Examples of the precursor include nickel-containing composite oxides; composite oxides containing nickel and a metal other than nickel (e.g., Co, Mn, Al, Ti, or Nb); nickel-containing composite hydroxides; and composite hydroxides containing nickel and a metal other than nickel.

Examples of a method for obtaining a nickel-containing composite oxide with a desired composition include a method of mixing raw material compounds (such as hydroxides and carbonates) in accordance with the target composition and decomposing them into a nickel-containing composite oxide through heat treatment, and a co-precipitation method of preparing a solution containing dissolved raw material compounds, obtaining a precursor precipitate having the target composition by adjusting temperature and pH and adding a complexing agent or the like, and then performing heat treatment on the precursor precipitate to obtain a nickel-containing composite oxide, a nickel-containing composite hydroxide, or the like. The following describes examples of methods of producing precursors, a nickel-containing composite oxide (hereinafter referred to simply as a “composite oxide”) and a nickel-containing composite hydroxide (hereinafter referred to simply as a “composite hydroxide”).

A method for obtaining a composite hydroxide may include a seed generation step, in which the pH and the like of a mixed solution containing metal ions in a desired composition ratio are adjusted to form a seed crystal, and a crystallization step, in which the generated seed crystal is grown to obtain a composite hydroxide with desired characteristics. In addition, a method for obtaining a composite oxide may include a seed generation step, in which the pH and the like of a mixed solution containing metal ions in a desired composition ratio are adjusted to form a seed crystal, a crystallization step, in which the generated seed crystal is grown to obtain a composite hydroxide with desired characteristics, and a step of obtaining a composite oxide by performing heat treatment on the obtained composite hydroxide. For further details on the methods for obtaining such composite oxides and composite hydroxides, reference may be made to, for example, JP 2003-292322 A and JP 2011-116580 A (US 2012/270107 A).

In the seed generation step, a liquid medium containing the seed crystal is prepared by adjusting the pH of a mixed solution containing nickel ions at a desired composition ratio to, for example, from 11 to 13. The seed crystal can include, for example, a hydroxide containing nickel in a desired proportion. The mixed solution can be prepared by dissolving a nickel salt in water at a desired ratio. Examples of the nickel salt include sulfate, nitrate, and hydrochloride. The mixed solution may contain, in addition to the nickel salt, another metal salt at a desired composition ratio, if necessary. The temperature in the seed generation step can be, for example, from 40° C. to 80° C. The atmosphere in the seed generation step can be a low oxidizing atmosphere, and for example, the oxygen concentration may be maintained at 10 vol % or less.

In the crystallization step, the produced seed crystal is grown to produce a precursor precipitate containing nickel having desired characteristics. The growth of seed crystal can be carried out, for example, by adding a mixed solution containing nickel ions and optionally other metal ions to a liquid medium containing the seed crystal while maintaining the pH in a range from 7 to 12.5, for example, and preferably in a range from 7.5 to 12. The addition time of the mixed solution is in a range from 1 hour to 24 hours, for example, and preferably from 3 hours to 18 hours. The temperature in the crystallization step can be, for example, from 40° C. to 80° C. The atmosphere in the crystallization step is the same as that in the seed generation step.

The pH adjustment in the seed generation step and the crystallization step can be performed using an acidic aqueous solution such as a sulfuric acid aqueous solution or a nitric acid aqueous solution, an alkaline aqueous solution such as a sodium hydroxide aqueous solution or ammonia water, or the like.

In the crystallization step, it is desirable to control the particle diameter of the precursor precipitate. The particle diameter of the precursor precipitate can be controlled by adjusting the temperature, pH, stirring speed, and the like of a reaction field. These conditions can be appropriately adjusted in accordance with actual conditions such as the shape of a container housing the reaction field, a starting material, and a rate at which the starting material is charged into the reaction field. In addition, the particle diameter of the precursor precipitate can be controlled by an aging time from the start of precipitation of the precursor precipitate, the stirring speed, and the like. Since the growth rate, shape and the like of particles vary depending on a shape of a reaction vessel, the conditions at this time may be appropriately adjusted in accordance with actual conditions.

In a case in which the precursor is a composite oxide, the composite oxide may be obtained by subjecting the precursor precipitate, which contains the composite hydroxide obtained in the crystallization step, to heat treatment in the composite oxide production process. The heat treatment may be carried out by heating the composite hydroxide at a temperature of, for example, 500° C. or less, preferably 350° C. or less. The heat treatment temperature may be, for example, 100° C. or higher, and preferably 200° C. or higher. A heat treatment time may be, for example, from 0.5 hours to 48 hours, preferably from 5 hours to 24 hours. An atmosphere of the heat treatment may be an air atmosphere or an atmosphere containing oxygen. The heat treatment may be performed using, for example, a box furnace, a rotary kiln furnace, a pusher furnace, a roller hearth kiln furnace, or the like.

The obtained precursor may contain a metal element other than nickel. Examples of another metal include Co, Mn, Al, Ti, and Nb, and at least one selected from this group is preferred. More preferably, the precursor contains at least one selected from the group consisting of Co, Mn, and Al. In a case in which the precursor contains another metal, it suffices that the mixed aqueous solution used to obtain the precursor precipitate contains metal ions in a desired composition. In this manner, both nickel and the other metal can be contained in the precursor precipitate, and the precursor having the desired composition can be obtained through heat treatment on the precursor precipitate.

The average particle diameter of the precursor is, for example, in a range from 2 μm to 6 μm, preferably in a range from 3 μm to 5 μm. The average particle diameter of the precursor is a volume-average particle diameter, and is a value at which the cumulative volume from the smaller particle diameter side reaches 50% in the volume distribution obtained by a laser scattering method.

In the synthesis step of synthesizing the lithium transition metal composite oxide, a heat-treated product is obtained by performing heat treatment on a lithium mixture obtained by mixing the precursor and the lithium compound at a temperature in a range from 550° C. to 1000° C. The obtained heat-treated product has a layered structure, and contains the lithium transition metal composite oxide containing nickel.

Examples of the lithium compound to be mixed with the precursor include lithium hydroxide, lithium carbonate, and lithium oxide. The particle diameter of the lithium compound used in the mixing, expressed as the volume-average particle diameter, is, for example, in a range from 0.1 μm to 100 μm, preferably in a range from 2 μm to 20 μm.

The ratio of the total number of moles of lithium to the total number of moles of metal elements constituting the precursor in the lithium mixture may be, for example, in a range from 0.95 to 1.2. The mixing of the precursor and the lithium compound can be carried out using, for example, a high-shear mixer or similar equipment.

The lithium mixture may further contain a metal element other than lithium and the metal elements constituting the precursor. Examples of another metal element include Al, Si, Zr, Ti, Mg, Ta, Nb, Mo, and W, and at least one selected from the group consisting of them is preferred. For example, in a case in which the lithium mixture contains another metal element such as W or Nb, the output characteristics can be improved. In a case in which the mixture contains Al, Zr, or the like, it is suitable for further improving cycle performance. In a case in which the lithium mixture contains Ti, Si, or the like, it is suitable for further improving cycle performance under high voltage conditions. In a case in which the lithium mixture contains the other metal element, it can be obtained by mixing a simple substance or a metal compound of the other metal element with the composite oxide and the lithium compound. Examples of metal compounds containing the other metal element include oxides, hydroxides, chlorides, nitrides, carbonates, sulfates, nitrates, acetates, and oxalates.

In a case in which the lithium mixture contains the other metal element, the ratio of the total number of moles of the metal elements constituting the precursor and the total number of moles of the other metal element may be, for example, 1:0.0001 to 1:0.1, preferably 1:0.0005 to 1:0.03, or 1:0.001 to 1:0.01.

The heat treatment temperature of the lithium mixture is, for example, in a range from 550° C. to 1000° C., but preferably in a range from 600° C. to 950° C., more preferably in a range from 700° C. to 950° C. The heat treatment of the lithium mixture may be performed at a single temperature; however, from the perspective of discharge capacity at high voltage, it is preferable to perform the treatment at a plurality of temperatures. When the heat treatment is performed at a plurality of temperatures, for example, it is desirable that the first temperature is held for a predetermined period, then the temperature is further raised, and the second temperature is held for a predetermined period. The first temperature is, for example, in a range from 200° C. to 600° C., preferably in a range from 400° C. to 500° C., and the second temperature is, for example, in a range from 600° C. to 900° C., preferably in a range from 650° C. to 750° C. The duration of the heat treatment is, for example, in a range from 0.5 hours to 48 hours. When heat treatment is performed at a plurality of temperatures, the duration at each temperature may range from 0.2 hours to 47 hours.

An atmosphere of the heat treatment may be an air atmosphere or an atmosphere containing oxygen. The heat treatment can be carried out using, for example, a box furnace, a rotary kiln furnace, a pusher furnace, or a roller hearth kiln furnace. The heat-treated product obtained in the synthesis step may be subjected to crushing treatment, a classification treatment, or the like, as necessary.

Cathode Active Material for Lithium-ion Battery

The cathode active material for a lithium-ion battery contains the lithium transition metal composite oxide and sulfate ions. The lithium transition metal composite oxide may contain the secondary particles formed by aggregation of the plurality of primary particles, and the secondary particles may have a volume-average particle diameter greater than 3 μm and less than 5 μm. The lithium transition metal composite oxide may have a layered structure, and contain lithium and nickel in a composition. The content of the sulfate ions in the cathode active material may be, for example, greater than 500 ppm and 6500 ppm or less on a mass basis. The details of the lithium transition metal composite oxide contained in the cathode active material are as described above.

The sulfate ions contained in the cathode active material may be derived from the above-described method of producing the cathode active material, and the sulfate ions may adhere to the surfaces of the lithium transition metal composite oxide particles. When sulfate ions are present on the surfaces of the lithium transition metal composite oxide particles, electrostatic repulsion between the particles increases. This facilitates a more uniform dispersion of the lithium transition metal composite oxide in the cathode composition prepared for forming the cathode active material layer, thereby preventing aggregation. As a result, it is presumable that the number of voids in the cathode active material layer is reduced, leading to an increased filling density of the cathode active material layer. In addition, the presence of sulfate ions on the surfaces of lithium transition metal composite oxide particles improves the wettability of the particle surfaces. It is presumable that this enhances the contact between the particles, enabling denser filling. Further, it is presumable that the sulfate ions may alter the chemical environment or chemical properties of the particle surfaces, potentially modifying the interactions between the particles. For example, it is presumable that, the sulfate ions may have a role of bridging between the particles, forming a more efficient filling structure.

The content of the sulfate ions in the cathode active material is preferably 1000 ppm or greater, 2000 ppm or greater, 3000 ppm or greater, 4000 ppm or greater, or 5000 ppm or greater, or preferably 8000 ppm or less, 7000 ppm or less, 6200 ppm or less, 6000 ppm or less, or 4000 ppm or less. The content of the sulfate ions in the cathode active material may preferably be in a range from 1000 ppm to 6200 ppm, or in a range from 2000 ppm to 6200 ppm. When the content of the sulfate ions is within the above range, gas generation in the cathode tends to be more effectively reduced, and the filling property tends to improve. The content of the sulfate ions in the cathode active material can be measured using an inductively coupled plasma (ICP) atomic emission spectrometer.

The cathode active material may further contain sodium ions in addition to the sulfate ions. The sodium ions may be derived from the above-described method of producing the cathode active material, and may adhere to the surfaces of the lithium transition metal composite oxide particles. The content of the sodium ions in the cathode active material may be, for example, in a range of 50 ppm to 1500 ppm, preferably 300 ppm or greater or 700 ppm or greater, and 1200 ppm or less or 1000 ppm or less. The content of the sodium ions in the cathode active material may preferably be in a range of 300 ppm to 1500 ppm, or in a range of 700 ppm to 1500 ppm. When the content of the sodium ions is within the above range, gas generation in the cathode tends to be more effectively reduced, and the filling property tends to improve. The content of the sodium ions in the cathode active material can be measured using an atomic absorption spectrometer (AAS).

In a case in which the cathode active material contains sulfate ions and sodium ions, the product of the content of the sulfate ions and the content of the sodium ions may be, for example, in a range of 0.6×10⁻⁶ to 1.5×10⁻⁵, preferably 1.0×10⁻⁶ or greater, 2.0×10⁻⁶ or greater, or 3.0×10⁻⁶ or greater, or 5.0×10⁻⁶ or greater, and 1.0×10⁻⁵ or less, or 8.0×10⁻⁶ or less. The product of the content of the sulfate ions and the content of the sodium ions may preferably be in a range of 1.0×10⁻⁶ to 1.0×10⁻⁵, in a range of 2.0×10⁻⁶ to 1.0×10⁻⁵, or in a range of 5.0×10⁻⁶ to 1.0×10⁻⁵. The product of the content of the sulfate ions and the content of the sodium ions is within the above range, the amount of gas generation during formation of a cathode is likely to be further reduced. It is presumable that the sulfate ions and sodium ions remaining on the cathode active material surface form a protective layer, and the direct reaction with the electrolytic solution is suppressed, thus reducing the amount of gas generation.

The volume-average particle diameter D₅₀ of the cathode active material may be, for example, in a range from 2 μm to 6 μm, preferably greater than 3 μm and less than 5 μm, or in a range from 3.5 μm to 4.5 μm. The cathode active material may be secondary particles formed by aggregation of a plurality of primary particles. As the average particle diameter D_{SEM} based on electron microscope observation, the average particle diameter of the primary particles constituting the secondary particles may be, for example, 1 μm or less, preferably 600 nm or less, 300 nm or less, or 100 nm or greater. The average particle diameter D_{SEM} based on electron microscope observation of the cathode active material is measured in a manner similar to that described above. The number of primary particles constituting the secondary particles of the cathode active material may be, for example, in a range from 20 to 10000, preferably in a range from 200 to 1000 based on electron microscope observation. In addition, in the cathode active material, the ratio of the volume-average particle diameter D₅₀ to the average particle diameter D_{SEM} based on electron microscope observation may be, for example, in a range from three to 20, preferably in a range from five to 10.

As the ratio of the number of moles of the boron elements contained in the boron compound to the total number of moles of metals other than lithium of the lithium transition metal composite oxide, the content of boron, which is the content of the boron compound in the cathode active material, may be, for example, less than 1 mol %, preferably less than 0.5 mol %, or less than 0.1 mol %. When the content of boron is within the above range, the electrode plate density of the cathode formed using the cathode active material tends to increase further. In particular, in a case in which the cathode active material contains 1 mol % or greater of a boron compound, and the layer composed of the boron compound is formed on the surface of the cathode active material, the electrode plate density tends to significantly decrease.

### Cathode Active Material Composition

The cathode active material composition contains a first lithium transition metal composite oxide that contains secondary particles formed by aggregation of a plurality of primary particles, the secondary particles having a volume-average particle diameter in a range from 2 μm to 6 μm, has a layered structure, and contains lithium and nickel in a composition, and a second lithium transition metal composite oxide that contains secondary particles formed by aggregation of a plurality of primary particles, the secondary particles having a volume-average particle diameter in a range from 10 μm to 25 μm, has a layered structure, and contains lithium and nickel in a composition.

By using a cathode active material composition that contains the first lithium transition metal composite oxide with a small particle diameter and the second lithium transition metal composite oxide with a large particle diameter, a cathode active material layer with an excellent filling property and high electrode plate density can be formed. In addition, a lithium-ion battery including a cathode including that cathode active material layer can suppress or reduce gas generation during charging and achieve excellent charge-discharge capacity.

The details of the first lithium transition metal composite oxide are the same as those of the above-described cathode active material. The volume-average particle diameter D₅₀ of the second lithium transition metal composite oxide may be, for example, in a range from 10 μm to 25 μm, preferably 12 μm or greater, 15 μm or greater, 20 μm or less, or 18 μm or less. The second lithium transition metal composite oxide may be the secondary particles formed by aggregation of a plurality of primary particles. The average particle diameter of the primary particles constituting the secondary particles of the second lithium transition metal composite oxide, as the average particle diameter D_{SEM} based on electron microscope observation, may be, for example, 1 μm or less, preferably 800 nm or less, 400 nm or less, or 200 nm or greater. As an average particle diameter DEM based on electron microscope observation of the second lithium transition metal composite oxide is measured in a manner similar to that described above. The number of primary particles constituting the secondary particles of the second lithium transition metal composite oxide may be, for example, in a range from 1000 to 500000, preferably in a range from 50000 to 100000. In addition, in the second lithium transition metal composite oxide, the ratio of the volume-average particle diameter D₅₀ to the average particle diameter D_{SEM} based on electron microscope observation may be, for example, 20 or greater, preferably in a range from 40 to 80. The details of the composition of the second lithium transition metal composite oxide are the same as those of the lithium transition metal composite oxide in the above-described cathode active material. In addition, the second lithium transition metal composite oxide can be produced by the same producing method as the above-described method of producing the lithium transition metal composite oxide. The method of producing the second lithium transition metal composite oxide preferably further includes the following step of covering, with a boron compound, at least a part of the surface of the second lithium transition metal composite oxide after the washing step and the drying step of the above-described producing method.

### Mixing Step

In the mixing step, the lithium transition metal composite oxide that has been washed with water and dried is mixed with a boron compound to obtain a mixture. The mixing of the lithium transition metal composite oxide and the boron compound may be carried out by either a dry method or a wet method. The mixing can be performed using, for example, a super mixer or the like. In addition, in this mixing step, a simple substance, an alloy, or a metal compound of another metal element may be mixed in addition to the boron compound. Examples of the other metal element include Al, Si, Zr, Ti, Mg, Ta, Nb, Mo, and W, and at least one selected from the group consisting of them is preferred.

The boron compound can be selected from at least one selected from the group consisting of boron oxide, boron oxoacids, and boron oxoacid salts. Specific examples of boron compounds include lithium tetraborate (Li₂B₄O₇), ammonium pentaborate (NH₄B₅O₈), orthoboric acid (H₃BO₃; commonly known as boric acid), lithium metaborate (LiBO₂), and boron oxide (B₂O₃). Among these, at least one selected from this group is preferred, with orthoboric acid being more preferable from a cost perspective.

The boron compound may be mixed with the lithium transition metal composite oxide in a solid state, or mixed, as a boron compound solution, with the lithium transition metal composite oxide. In a case in which the boron compound in a solid state is used, the volume-average particle diameter of the boron compound may be, for example, in a range from 1 μm to 60 μm, preferably in a range from 10 μm to 30 μm.

As the ratio of the number of moles of the boron element to the total number of moles of metals other than lithium of the lithium transition metal composite oxide, the content of the boron compound in the mixture may be, for example, in a range from 0.1 mol % to 2 mol %, preferably in a range from 0.1 mol % to 1.5 mol %, more preferably in a range from 0.1 mol % to 1.2 mol %.

### Heat Treatment Step

In the heat treatment step, the mixture is subjected to heat treatment at a temperature in a range from 100° C. to 450° C. to obtain a cathode active material, for example. The temperature of the heat treatment may be in a range from 200° C. to 400° C., preferably in a range from 220° C. to 350° C., and more preferably in a range from 250° C. to 350° C. By setting the heat treatment temperature higher than the drying treatment temperature, charge-discharge capacity may be further improved. An atmosphere of the heat treatment may be an oxygen-containing atmosphere or an air atmosphere. The heat treatment duration may be, for example, in a range from one hour to 20 hours, preferably in a range from five hours to 10 hours. The heat-treated product produced in the heat treatment step may be subjected to a crushing treatment, a classification treatment, or the like, as necessary.

After the washing step, a lithium-deficient region may be formed near the surface of the second lithium transition metal composite oxide. In this lithium-deficient region, the insertion and extraction of lithium ions may be hindered. However, it is presumable that mixing the second lithium transition metal composite oxide after the washing step with a boron compound and performing heat treatment can compensate the lithium deficiency and suppress the inhibition of lithium-ion insertion and extraction, thus leading to improved charge-discharge characteristics and cycle performance.

For the content ratio of the first lithium transition metal composite oxide and the second lithium transition metal composite oxide in the cathode active material composition, the content ratio of the first lithium transition metal composite oxide to the total content of the first lithium transition metal composite oxide and the second lithium transition metal composite oxide may be, for example, in a range from 50 mass % to 90 mass %, 60 mass % or greater, 80 mass % or less, or 70 mass % or less. In addition, preferably it is in a range from 50 mass % to 80 mass % or less, in a range from 50 mass % to 70 mass %, in a range from 60 mass % to 90 mass %, in a range from 60 mass % to 80 mass %, or in a range from 60 mass % to 70 mass %. In a case in which the content ratio of the first lithium transition metal composite oxide and the second lithium transition metal composite oxide is within the above range, the second lithium transition metal composite oxide is efficiently filled between the particles of the first lithium transition metal composite oxide, and thus the electrode plate density tends to increase.

Electrode for Lithium-ion Battery

A lithium-ion battery electrode includes a current collector and a cathode active material layer disposed on the current collector. The cathode active material layer contains the above-described cathode active material or a cathode active material produced by the above-described producing method. A non-aqueous electrolyte secondary battery including such an electrode can suppress or reduce gas generation during charging and achieve excellent charge-discharge capacity.

The density of the cathode active material layer may be, for example, in a range from 2.6 g/cm³ to 3.9 g/cm³, preferably in a range from 2.8 g/cm³ to 3.8 g/cm³, more preferably in a range from 3.1 g/cm³ to 3.7 g/cm³, still more preferably in a range from 3.2 g/cm³ to 3.6 g/cm³. The density of the active material layer is calculated by dividing the mass of the active material layer by the volume of the active material layer. Here, the density of the active material layer can be adjusted by applying a pressure after the electrode composition described later is applied on the current collector.

Examples of the material of the current collector include aluminum, nickel, and stainless steel. The cathode active material layer can be formed by applying, onto the current collector, an electrode composition obtained by mixing the above-described cathode active material, a conductive material, a binder, and the like with a solvent, followed by drying treatment and pressing treatment, for example. Examples of the conductive material include natural graphite, artificial graphite, and acetylene black. Examples of the binder include polyvinylidene fluoride, polytetrafluoroethylene, and polyamide acrylic resin. As the solvent, N-methyl-2-pyrrolidone (NMP) or the like can be used.

### Lithium-Ion Battery

The lithium-ion battery includes the above-mentioned electrode for a lithium-ion battery. The lithium-ion battery includes an anode for a lithium-ion battery, a non-aqueous electrolyte, a separator, and the like in addition to the electrode for a lithium-ion battery. As the anode, a non-aqueous electrolyte, a separator, and the like in the lithium-ion battery, the components for lithium-ion batteries disclosed in JP 2002-075367 A, JP 2011-146390 A, JP 2006-12433 A (the entire disclosure of which is incorporated herein by reference), and the like may be used as necessary, for example.

### EXAMPLES

Certain embodiment(s) of the present disclosure is specifically described below through examples; however, the present disclosure is not limited to these examples. As a volume-average particle diameter, a value at which the cumulative volume from the smaller particle diameter side in the volume distribution obtained by a laser scattering method was 50% was used. Specifically, the volume-average particle diameter was measured using a laser diffraction particle diameter distribution analyzer (MALVERN Inst, MASTERSIZER 2000). The composition, the sulfate ion content, and the sodium ion content were measured using a solution obtained by dissolving the sample in hydrochloric acid. A composition was measured using the inductively coupled plasma atomic emission spectrometer (ICP-AES; manufactured by PerkinElmer Co., Ltd.). The sulfate ion content was measured using an ICP-AES (manufactured by Hitachi, Ltd.). The sodium ion content (Na amount) was measured using an atomic absorption spectrometer (AAS; manufactured by Hitachi, Ltd.).

### Example 1

### Precursor Preparation Step

By means of a co-precipitation method, composite hydroxide particles with a composition represented by (Ni_{0.827}Co_{0.13}Mn_{0.043})(OH)₂ were obtained. The secondary particles thereof had a volume-average particle diameter of 4 μm.

### Synthesis Step

The obtained composite hydroxide particles were mixed with lithium hydroxide, aluminum hydroxide, zirconium oxide, and niobium oxide at a molar ratio of Li:(Ni+Co+Mn):Al:Zr:Nb=1.030:0.991:0.002:0.004:0.003 to prepare a raw material mixture. The resulting raw material mixture was heat-treated in an oxygen-containing atmosphere (oxygen content: 40 vol %). The heat treatment was performed at a first temperature of 450° C. for three hours and a second temperature of 780° C. for four hours. After the heat treatment, dispersion treatment was carried out, and first particles of a lithium transition metal composite oxide with the composition Li_{1.03}Ni_{0.825}Co_{0.13}Mn_{0.043}Al_{0.002}(Zr_{0.004}Nb_{0.003})O₂ were obtained.

### Washing Step

The obtained first particles were added to a sodium sulfate aqueous solution prepared so as to have a sodium-ion concentration of 0.141 mol/L, forming a slurry (mixture) with a solid content concentration of 45 mass %. The solid content concentration was obtained by a mass of the first particles/(a mass of the first particles+a mass of the washing liquid). This slurry was stirred for 10 minutes. Subsequently, a lithium sulfate aqueous solution was added, which had been prepared so as to have a lithium-ion concentration of 4.55 mol/L, thus adjusting the lithium-ion concentration in the slurry to 0.182 mol/L, followed by stirring for three minutes. In the slurry derived from the sodium sulfate aqueous solution and the lithium sulfate aqueous solution, the sulfate-ion concentration was 0.85 mass %, the sodium-ion concentration was 0.18 mass %, and the lithium-ion concentration was 0.07 mass %. The slurry was then dehydrated using a funnel, and separated as a cake. The cake obtained by the separation was dried in a nitrogen atmosphere at 250° C. for 10 hours, thus obtaining a cathode active material E1, which contains a target lithium transition metal composite oxide. The obtained cathode active material E1 had a volume-average particle diameter D₅₀ of 4 μm and a primary particle average diameter D_{SEM} of 0.6 μm.

### Example 2

Except for changing the amount of sodium sulfate added as shown in Table 1 to adjust the sodium-ion concentration in the slurry during the washing step to 0.282 mol/L, the same procedure as in Example 1 was performed to obtain a cathode active material E2. In the slurry derived from the sodium sulfate aqueous solution and the lithium sulfate aqueous solution, the sulfate-ion concentration was 1.22 mass %, the sodium-ion concentration was 0.36 mass %, and the lithium-ion concentration was 0.07 mass %.

### Example 3

Except for changing the amount of lithium sulfate added as shown in Table 1 to adjust the lithium-ion concentration in the slurry during the washing step to 0.727 mol/L, the same procedure as in Example 1 was performed to obtain a cathode active material E3. In the slurry derived from the sodium sulfate aqueous solution and the lithium sulfate aqueous solution, the sulfate-ion concentration was 2.29 mass %, the sodium-ion concentration was 0.18 mass %, and the lithium-ion concentration was 0.28 mass %.

### Example 4

Except for changing the amounts of sodium sulfate and lithium sulfate added as shown in Table 1 to adjust the sodium-ion concentration to 0.563 mol/L and the lithium-ion concentration to 0.727 mol/L in the slurry during the washing step, the same procedure as in Example 1 was performed to obtain a cathode active material E4. In the slurry derived from the sodium sulfate aqueous solution and the lithium sulfate aqueous solution, the sulfate-ion concentration was 3.40 mass %, the sodium-ion concentration was 0.71 mass %, and the lithium-ion concentration was 0.28 mass %.

### Example 5

Except for preparing the lithium sulfate aqueous solution during the washing step such that the lithium-ion concentration was 0.727 mol/L in the slurry and using pure water instead of sodium sulfate aqueous solution during the washing step, the same procedure as in Example 1 was performed to obtain a cathode active material E5. In the slurry derived from the sodium sulfate aqueous solution and the lithium sulfate aqueous solution, the sulfate-ion concentration was 1.92 mass %, the sodium-ion concentration was 0 mass %, and the lithium-ion concentration was 0.28 mass %.

### Comparative Example 1

Except for setting the volume-average particle diameter of the secondary particles to 5 μm in the precursor preparation step, the same procedure as in Example 1 was performed to obtain a cathode active material C1.

### Comparative Example 2

Except for setting the volume-average particle diameter of the secondary particles to 3 μm in the precursor preparation step, the same procedure as in Example 1 was performed to obtain a cathode active material C2.

### Comparative Example 3

Except for using pure water instead of a sodium sulfate aqueous solution in the washing step and omitting the addition of a lithium sulfate aqueous solution, followed by stirring for 13 minutes, the same procedure as in Example 1 was performed to obtain a cathode active material C3.

### Comparative Example 4

The sodium sulfate aqueous solution in the washing step was prepared such that a sodium-ion concentration was 0.845 mol/L. Subsequently, a lithium sulfate aqueous solution was added to adjust the lithium sulfate-ion concentration in the slurry to 1.09 mol/L. Except for this, the same procedure as in Example 1 was performed to obtain a cathode active material C4. In the slurry derived from the sodium sulfate aqueous solution and the lithium sulfate aqueous solution, the sulfate-ion concentration was 5.11 mass %, the sodium-ion concentration was 1.07 mass %, and the lithium-ion concentration was 0.42 mass %.

### Comparative Example 5

The sodium sulfate aqueous solution in the washing step was prepared such that a sodium-ion concentration was 1.13 mol/L. Subsequently, a lithium sulfate aqueous solution was added to adjust the lithium sulfate-ion concentration in the slurry to 1.456 mol/L. Except for this, the same procedure as in Example 1 was performed to obtain a cathode active material C5. In the slurry derived from the sodium sulfate aqueous solution and the lithium sulfate aqueous solution, the sulfate-ion concentration was 6.81 mass %, the sodium-ion concentration was 1.42 mass %, and the lithium-ion concentration was 0.56 mass %.

### Reference Example 1

### Precursor Preparation Step

By means of a co-precipitation method, composite oxide particles including secondary particles with a volume-average particle diameter of 17 μm and having a composition represented by (Ni_{0.83}Co_{0.05}Mn_{0.012})O₂ was obtained.

### Synthesis Step

The obtained composite oxide particles, lithium hydroxide, aluminum hydroxide, and zirconium oxide were mixed in such a way that the molar ratio of Li:(Ni+Co+Mn): Al: Zr became 1.10:0.975:0.02:0.005, thereby obtaining a raw material mixture. The obtained raw material mixture was then heat-treated in an oxygen atmosphere. The heat treatment was carried out at a first temperature of 450° C. for three hours and at a second temperature of 790° C. for four hours. After the heat treatment, dispersion treatment was performed to obtain first particles of a lithium transition metal composite oxide having the composition Li_{1.10}Ni_{0.82}Co_{0.05}Mn_{0.12}Al_{0.02}(Zr_{0.005})O₂.

### Washing Step

The obtained first particles were added to a sodium sulfate aqueous solution prepared such that the sodium-ion concentration was 0.141 mol/L, thereby forming a slurry with a solid content concentration of 45 mass %. The solid content concentration was obtained by a mass of the first particles/(a mass of the first particles+a mass of the washing liquid). This slurry was stirred for 25 minutes. Subsequently, a lithium sulfate aqueous solution prepared such that the lithium-ion concentration was 4.55 mol/L was added to the slurry such that the lithium-ion concentration in the slurry became 0.182 mol/L, and then stirring was performed for 5 minutes. The slurry derived from the sodium sulfate aqueous solution and the lithium sulfate aqueous solution had a sulfate-ion concentration (SO₄ concentration) of 0.85 mass %, a sodium-ion concentration (Na concentration) of 0.18 mass %, and a lithium-ion concentration (Li concentration) of 0.07 mass %. The slurry was then dehydrated using a funnel, and separated as a cake. The cake obtained by the separation was dried in a nitrogen atmosphere at 250° C. for 10 hours to obtain second particles.

### Mixing Step

Orthoboric acid in an amount corresponding to 1 mol % in terms of the boron element with respect to the total number of moles of metals other than lithium in the lithium transition metal composite oxide contained in the obtained second particles was added and mixing and stirring were performed to obtain a mixture.

### Heat Treatment Step

The obtained mixture was heat-treated in an air atmosphere at 300° C. for 10 hours to obtain a cathode active material C6 (aggregated large particles) containing the desired lithium transition metal composite oxide.

### Reference Example 2

### Precursor Preparation Step

By means of a co-precipitation method, composite oxide particles including secondary particles with a volume-average particle diameter of 4 μm and having a composition represented by (Ni_{0.847}Co_{0.11}Mn_{0.043})O₃.

### Synthesis Step

The obtained composite oxide particles were mixed with lithium hydroxide, aluminum hydroxide, and zirconium oxide in a molar ratio of Li:(Ni+Co+Mn):Al: Zr=1.030:0.994:0.002:0.004 to obtain a raw material mixture. The obtained raw material mixture was then heat-treated in an oxygen atmosphere. The heat treatment was performed at a first temperature of 450° C. for three hours, a second temperature of 860° C. for seven hours, and a third temperature of 780° C. for five hours. After the heat treatment, dispersion treatment was carried out to obtain first particles of a lithium transition metal composite oxide having a composition of Li_{1.03} Ni_{0.845}Co_{0.11}Mn_{0.043}Al_{0.002}(Zr_{0.004})O₂.

### Secondary Baking Step

The obtained first particles were mixed with cobalt oxide in a molar ratio of (Ni+Co+Mn):Co=0.98:0.02 to prepare a mixture. The obtained mixture was subjected to heat treatment in an oxygen atmosphere. The heat treatment was carried out at a temperature of 700° C. for six hours. After the heat treatment, dispersion treatment was carried out to obtain a cathode active material C7, which includes a lithium transition metal composite oxide having a composition of Li_{1.03} Ni_{0.825}Co_{0.13}Mn_{0.043}Al_{0.002}(Zr_{0.004})O₂. The volume-average particle diameter D₅₀ of the obtained single particles was 4 μm, and the average particle diameter D_{SEM} of the primary particles was 1.4 μm.

### Evaluation of Cathode Electrode Plate Density

The cathode active materials obtained in Examples 1 to 5 and Comparative Examples 1 to 5 were evaluated for electrode plate density as follows.

### Production of Cathode

The cathode active material C6 (aggregated large particles) of Reference Example 1 was mixed with the cathode active materials (aggregated small particles) of each Example or Comparative Example in a mass ratio of 7:3 to obtain cathode active material compositions according to the Examples and Comparative Examples. In addition, the cathode active material C6 (aggregated large particles) of Reference Example 1 was mixed with the cathode active material of Reference Example 2 in a mass ratio of 7:3 to obtain a cathode active material composition of Reference Example 3.

A cathode mixture was prepared by dispersing 97.5 parts by mass of the cathode active material composition, 1.5 parts by mass of acetylene black, and 1 part by mass of polyvinylidene fluoride (PVDF) in N-methyl-2-pyrrolidone (NMP). The obtained cathode mixture was then applied to an aluminum foil current collector, followed by drying and cutting into a predetermined size.

### Measurement of Electrode Plate Density

Under the above-described cathode fabrication conditions, evaluation cathodes were produced, and their electrode plate densities were measured. Each of the cathodes was compressed using an electric press machine, and the electrode plate thickness of the cathode after pressing was measured with a micrometer. The thickness of the aluminum foil current collector was subtracted from the total electrode plate thickness to calculate the thickness of the cathode mixture. The electrode plate density was then calculated based on the obtained thickness and mass of the cathode mixture. The press pressure applied in compression was set to 160 kN. A higher electrode plate density indicates a better filling property.

### Production of Cathode

The cathode was fabricated by compressing and molding each of the cathodes prepared under the above-described conditions using a roll press machine.

### Production of Negative Electrode

Artificial graphite in an amount of 97.5 parts by mass, 1.5 parts by mass of carboxymethyl cellulose (CMC), and 1.0 parts by mass of styrene butadiene rubber (SBR) were dispersed and dissolved in pure water to prepare a negative electrode slurry. The obtained negative electrode slurry was applied to a current collector made of copper foil, dried, compression-molded by a roll press machine, and cut into a predetermined size to prepare a negative electrode.

After attaching leads to the cathode and anode current collectors, a separator was disposed between the cathode and anode, and these components were housed in a pouch-shaped laminate pack. Subsequently, this was vacuum-dried at 60° C. to remove moisture adsorbed to members. Thereafter, an electrolytic solution was injected into the laminate pack under an argon atmosphere and sealed to produce a battery for evaluation.

### Evaluation of Storage Characteristics

The gas generation amount was measured using the cathode active materials from Examples 1 to 4 and Comparative Examples 1 to 5. First, the battery for evaluation was placed in a thermostatic chamber at 25° C., and three charge-discharge cycles were performed under conditions of 2.5 V to 4.2 V using a charge-discharge test system (TOSCAT-3100, manufactured by TOYO SYSTEM Co., LTD.). Subsequently, a constant current-constant voltage charge at 4.2 V was performed at a charging rate of 0.2 C for 8 hours. After charging, the battery for evaluation was disassembled under an argon atmosphere, and the charged-state cathode was extracted. Subsequently, the extracted cathode was housed in a laminate pack, an electrolytic solution was injected thereinto, and the laminate pack was sealed under reduced pressure. The obtained evaluation laminate pack was stored in a thermostatic chamber at 80° C. for 48 to 168 hours. After a predetermined storage period, the evaluation laminate pack was taken out and cooled for one hour under a 25° C. atmosphere, and the volume change of the evaluation laminate pack before and after storage at 80° C. was measured. The gas generation amount (cm³) during storage at 80° C. was then obtained. The standard value for each sample, which was obtained by dividing the obtained gas generation amount by the mass of the cathode active material layer, relative to the standard value of Reference Example 3, which was set as 100% was calculated as the relative gas generation amount (%) and shown in Table 1. The volume change was obtained by measuring the volumes of the evaluation laminate pack before and after storage at 80° C. using Archimedes' principle and calculating the difference therebetween.

TABLE 1

| | | | Slurry | | | | | | | Cathode | |
|---|---|---|---|---|---|---|---|---|---|---|---|
| | | | | | | SO₄ Concen- | | | | | Relative |
| | | | SO₄ | Na | Li | tration × | Cathode Active Material | | | Electrode | Amount of |
| | | | Concen- | Concen- | Concen- | Na Concen- | | | Na × | Plate | Gas |
| | D50 | DSEM | tration | tration | tration | tration × | Na | SO₄ | SO₄ × | Density | Generation |
| | (μm) | (μm) | (mass %) | (mass %) | (mass %) | 10⁻⁴ | (ppm) | (ppm) | 10⁻⁶ | (g/cm³) | (%) |
| Example 1 | 4 | 0.6 | 0.85 | 0.18 | 0.07 | 0.15 | 390 | 1700 | 0.66 | 3.57 | 99 |
| Example 2 | 4 | 0.6 | 1.22 | 0.36 | 0.07 | 0.44 | 780 | 2400 | 1.87 | 3.60 | 96 |
| Example 3 | 4 | 0.6 | 2.29 | 0.18 | 0.28 | 0.41 | 340 | 3100 | 1.05 | 3.58 | 100 |
| Example 4 | 4 | 0.6 | 3.40 | 0.71 | 0.28 | 2.42 | 1400 | 6000 | 8.40 | 3.60 | 87 |
| Example 5 | 4 | 0.6 | 1.92 | 0.00 | 0.28 | 0.00 | 50 | 3400 | 0.17 | 3.56 | 100 |
| Comprative | 5 | 0.6 | 0.85 | 0.18 | 0.07 | 0.15 | 370 | 1500 | 0.56 | 3.50 | 89 |
| Example 1 | | | | | | | | | | | |
| Comprative | 3 | 0.6 | 0.85 | 0.18 | 0.07 | 0.15 | 420 | 1600 | 0.67 | 3.56 | 106 |
| Example 2 | | | | | | | | | | | |
| Comprative | 4 | 0.6 | 0.00 | 0.00 | 0.00 | 0.00 | 20 | 400 | 0.01 | 3.52 | 105 |
| Example 3 | | | | | | | | | | | |
| Comprative | 4 | 0.6 | 5.11 | 1.07 | 0.42 | 5.45 | 1900 | 8600 | 16.34 | 3.47 | 84 |
| Example 4 | | | | | | | | | | | |
| Comprative | 4 | 0.6 | 6.81 | 1.42 | 0.56 | 9.69 | 1900 | 9500 | 18.05 | 3.46 | 82 |
| Example 5 | | | | | | | | | | | |
| Reference | 4 | 1.5 | — | — | — | — | 90 | 1000 | 0.09 | 3.55 | 100 |
| Example 2 | | | | | | | | | | | |

Regarding the electrode plate density, as shown in Table 1, the cathode active material C1 of Comparative Example 1, in which the secondary particles have a volume-average particle diameter of 5 μm, exhibited a low and inferior electrode plate density. The cathode active material E1 of Example 1 and the cathode active material C2 of Comparative Example 2 both exhibited excellent electrode plate density. This is presumably because, for example, having a D₅₀ exceeding 3 μm and less than 5 μm enhances the filling property with aggregated large particles.

For the cathode active materials C4 and C5 of Comparative Examples 4 and 5, even though the volume-average particle diameter of the secondary particles was 4 μm, the electrode plate density was low and inferior compared to Examples. This is presumably because, for Examples, the amount of residual sulfate ions and sodium ions in the cathode active material was within a predetermined range, leading to modification of the particle surface state. As a result, the bonding and contact between particles were improved, thereby enhancing the filling density compared to Comparative Examples 4 and 5.

Regarding storage characteristics, as shown in Table 1, the battery for evaluation using the cathode active material C3 of Comparative Example 3 exhibited a large gas generation amount and inferior battery performance. The batteries for evaluation using the cathode active materials E1 to E4 of Examples 1 to 4 and the cathode active materials C4 and C5 of Comparative Examples 4 and 5 were excellent in terms of gas generation. This is presumably because the gas generation was suppressed when the amount of residual sulfate ions in the cathode active material was within a predetermined range. Further, when comparing E3 and E4, in a case in which the amount of residual sulfate ions in the cathode active material was at a similar level, the electrode plate density was improved when the amount of sodium ions was within a predetermined range.

It is to be understood that although the present disclosure has been described with regard to preferred embodiments thereof, various other embodiments and variants may occur to those skilled in the art, which are within the scope and spirit of the disclosure, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for producing a cathode active material for a lithium-ion battery, the method comprising:
preparing a mixture comprising a lithium transition metal composite oxide containing lithium and nickel in a composition and containing secondary particles formed by aggregation of a plurality of primary particles, the secondary particles having a volume-average particle diameter greater than 3 μm and less than 5 μm, and a treatment solution containing a sulfate ion and a liquid medium, a concentration of the sulfate ion being in a range of 0.5 mass % to 5 mass %; and
removing the treatment solution from the mixture.

2. The method according to claim 1, wherein in the lithium transition metal composite oxide, a ratio of the number of moles of nickel atoms to the total number of moles of metal atoms other than lithium atoms is 0.7 or greater and less than 1.

3. The method according to claim 1, wherein in the lithium transition metal composite oxide, a ratio of the number of moles of cobalt atoms to the total number of moles of metal atoms other than lithium atoms is 0.01 or greater and less than 0.2.

4. The method according to claim 1, wherein a mass ratio of the lithium transition metal composite oxide to the mixture is in a range of 30 mass % to 60 mass %.

5. The method according to claim 1, wherein the mixture contains a sodium ion at a concentration in a range of 0.1 mass % to 2 mass %.

6. The method according to claim 1, wherein an average particle diameter of the primary particles is 1 μm or less.

7. A cathode active material for a lithium-ion battery, comprising: a lithium transition metal composite oxide containing lithium and nickel in a composition and containing secondary particles formed by aggregation of a plurality of primary particles, the secondary particles having a volume-average particle diameter greater than 3 μm and less than 5 μm; and
a sulfate ion, wherein
the content of the sulfate ion is greater than 500 ppm and 6500 ppm or less, and in the lithium transition metal composite oxide, the content of boron with respect to the total number of moles of metals other than lithium is less than 1 mol %.

8. The cathode active material according to claim 7, wherein a ratio of the number of moles of nickel atoms to the total number of moles of metal atoms other than lithium atoms is 0.7 or greater and less than 1.

9. The cathode active material according to claim 7, wherein a ratio of the number of moles of cobalt atoms to the total number of moles of metal atoms other than lithium atoms is 0.01 or greater and less than 0.2.

10. The cathode active material according to claim 7, further comprising a sodium ion, wherein the content of the sodium ion in the cathode active material is in a range of 100 ppm to 1500 ppm.

11. The cathode active material according to claim 10, wherein a product of the content of the sulfate ion and the content of the sodium ion in the cathode active material is in a range of 0.6×10⁻⁶ to 8.4×10⁻⁶.
